(19) United States
(12) Patent Application Publication
(10) Pub. No.: US 2025/0333307 A1
(43) Pub. Date: Oct. 30, 2025

(54) Hard Carbon Derived from a Thermoset Polymer using Lignin Liquefaction in Glycerol/Ethylene Glycol and a Crosslinking Reagent

(71) Applicant: GM Global Technology Operations LLC, Detroit, MI (US)

(72) Inventors: Nathaniel HARDIN, Warren, MI (US); Yifan ZHAO, Warren, MI (US)

(21) Appl. No.: 18/648,947

(22) Filed: Apr. 29, 2024

(51) Int. Cl. C01B 32/05

(52) U.S. Cl. CPC C01B 32/05; C01P 2006/40

(57) ABSTRACT

A method for forming hard carbon, a hard carbon, and a hard carbon anode is provided. The method includes liquifying lignin in at least one of glycerol or glycerol/ethylene glycol with an acid catalyst to form a first monomer of liquified lignin. The method includes providing a second monomer including a crosslinking reagent to the first monomer of liquified lignin to facilitate controlled polymerization resulting in a resin having controlled size and morphology, Additionally, the method includes pyrolyzing the resin to form the hard carbon with a controlled morphology. The first monomer and the second monomer are provided in a ratio of 10 wt. % to 90 wt. %.

### GOVERNMENT LICENSE RIGHTS

This invention was made with government support under United States Department of Energy (USDOE) contract DE-FOA-0003236 awarded by the United States Department of Energy. The government has certain rights to the invention.

### INTRODUCTION

The present disclosure relates to a hard carbon material, and more particularly, to a hard carbon formed from liquified lignin and having a controlled morphology.

Hard carbon is a form of carbon that cannot be converted into graphite by heat treatment. Hard carbon may be produced by heating carbonaceous precursors in an absence of oxygen. Some precursors for forming hard carbon include lignin, polyvinylidene chloride (PVDC), and sucrose. Hard carbon is a low-density material with high microporosity and can be used as a material in forming anode materials. However, most organic precursors do not allow morphology tunability of hard carbon.

While prior art methods and systems attempt to minimize the disadvantages of using hard carbon for anode materials and may achieve their particular purpose, a need still exists for a new and improved hard carbon and hard carbon anode. Accordingly, a stable and efficient hard carbon is needed.

### SUMMARY

According to several aspects of the present disclosure, a method for forming hard carbon is provided. The method includes liquifying lignin in at least one of glycerol or glycerol/ethylene glycol with an acid catalyst to form a first monomer of liquified lignin. The method includes providing a second monomer including a crosslinking reagent to the first monomer of liquified lignin to facilitate controlled polymerization resulting in a resin having controlled size and morphology, Additionally, the method includes pyrolyzing the resin to form the hard carbon with a controlled morphology. The first monomer and the second monomer are provided in a ratio of 10 wt. % to 90 wt. %.

In accordance with another aspect of the disclosure, the method includes a lignin including at least one of kraft lignin, enzymatic lignin, sulfonated lignin, lignocellulose, or alkyl-lignin.

In accordance with another aspect of the disclosure, the method includes lignin between 10 wt. % and 90 wt. % of the liquified lignin.

In accordance with another aspect of the disclosure, the method includes liquifying the lignin using glycerol in an amount between 10 wt. % and 90 wt. % of the liquified lignin.

In accordance with another aspect of the disclosure, the method includes liquifying the lignin using glycerol/ethylene glycol in an amount between 10 wt. % and 90 wt. % of the liquified lignin.

In accordance with another aspect of the disclosure, the method includes an acid catalyst between 0.1 wt. % and 50 wt. % of the liquified lignin.

In accordance with another aspect of the disclosure, the method includes an acid catalyst including at least one of phosphoric acid or hydrochloric acid.

In accordance with another aspect of the disclosure, the method includes an acid catalyst including at least one of nitric acid or sulfuric acid.

In accordance with another aspect of the disclosure, the method includes a crosslinking reagent including at least one of epoxy or isocyanate.

In accordance with another aspect of the disclosure, the method includes a crosslinking reagent including at least one of formaldehyde or an ester.

In accordance with another aspect of the disclosure, the method includes a crosslinking reagent including at least one of an acid or an acid chloride.

In accordance with another aspect of the disclosure, the method includes providing a controlled polymerization further including using bulk polymerization.

In accordance with another aspect of the disclosure, the method includes providing a controlled polymerization further including using spray polymerization.

In accordance with another aspect of the disclosure, the method includes providing a controlled polymerization further including using emulsion polymerization.

In accordance with another aspect of the disclosure, the method includes providing a controlled polymerization further including using extrusion polymerization.

In accordance with another aspect of the disclosure, the method includes pyrolyzing the resin further including pyrolyzing the resin at a temperature between 700° C. and 1600° C.

In accordance with another aspect of the disclosure, the method includes hard carbon having a spherical morphology.

According to several aspects of the present disclosure, a hard carbon for forming a hard carbon anode is provided. The hard carbon includes a lignin-derived hard carbon having a spherical morphology. The lignin-derived hard carbon is formed by liquifying lignin in at least one of glycerol or glycerol/ethylene glycol with an acid catalyst to form a liquified lignin, providing controlled polymerization by adding a crosslinking reagent to the liquified lignin resulting in a resin having a controlled size and morphology, and pyrolyzing the resin to form the hard carbon with a controlled morphology.

In accordance with another aspect of the disclosure, the hard carbon includes a lignin further including at least one of kraft lignin, enzymatic lignin, sulfonated lignin, lignocellulose, or alkyl-lignin.

According to several aspects of the present disclosure, a hard carbon anode is provided. The hard carbon anode includes an anode including lignin-derived hard carbon having a spherical morphology. The lignin-derived hard carbon is formed by liquifying lignin in at least one of glycerol or glycerol/ethylene glycol with an acid catalyst to form a liquified lignin, providing controlled polymerization by adding a crosslinking reagent to the liquified lignin resulting in a resin having a controlled size and morphology, and pyrolyzing the resin to form the hard carbon with a controlled morphology.

Further areas of applicability of the present disclosure will become apparent from the detailed description provided below. It should be understood that the detailed description and specific examples are intended for purposes of illustration only and are not intended to limit the scope of the disclosure.

The above features and advantages, and other features and advantages, of the presently disclosed system and method are readily apparent from the detailed description, including the claims, and examples when taken in connection with the accompanying drawings.

### BRIEF DESCRIPTION OF THE DRAWINGS

The present disclosure will become more fully understood from the detailed description and the accompanying drawings, wherein:

FIG. 1 is a perspective view illustrating an example of a vehicle including a battery pack having a plurality of battery cells, in accordance with the present disclosure.

FIG. 2 is a perspective view illustrating a battery cell disposed within the battery pack shown in FIG. 1, where the battery cell includes at least one electrode stack having a hard carbon anode derived from lignin feedstock, in accordance with the present disclosure.

FIG. 3 is a flowchart illustrating a method for forming hard carbon suitable for use in the hard carbon anode as shown in FIG. 2, in accordance with the present disclosure.

### DETAILED DESCRIPTION

Reference will now be made in detail to several examples of the disclosure that are illustrated in accompanying drawings. Whenever possible, the same or similar reference numerals are used in the drawings and the description to refer to the same or like parts or steps. The following description is merely exemplary in nature and is not intended to limit the present disclosure, application, or uses.

Hard carbon materials can be produced by pyrolysis of organic materials. Conventional hard carbon is formed from a variety of feed stock including resins (e.g., resin, bakelite), coal tar, biopolymer (e.g., cellulose, chitin, lignin), and so forth. When used as anode material, hard carbon anodes have a fast charge capability but a low temperature capability. Hard carbon anodes have a large difference in performance depending on the starting materials. The best hard carbons are formed from resins but are also the most expensive. The cheapest hard carbons are bio-based or formed from coal tar but also have the worst performance and no morphology control. The hard carbon and hard carbon anode disclosed herein includes a hard carbon derived from pyrolysis of a thermosetting material using feed stocks including lignin, glycerol, and/or ethylene glycol with an acid catalyst and crosslinking reagents. This hard carbon allows for lower cost hard carbon anode production because a majority of biomass used as feed stock includes biowaste feeds including the lignin and crude glycerol, which can facilitate morphology tunability. Moreover, using biowaste as a feed stock to make thermosetting polymers allows for morphology control and tunability of polymers before pyrolysis, which in turn allows for control over characteristics (e.g., morphology) of the final hard carbon product.

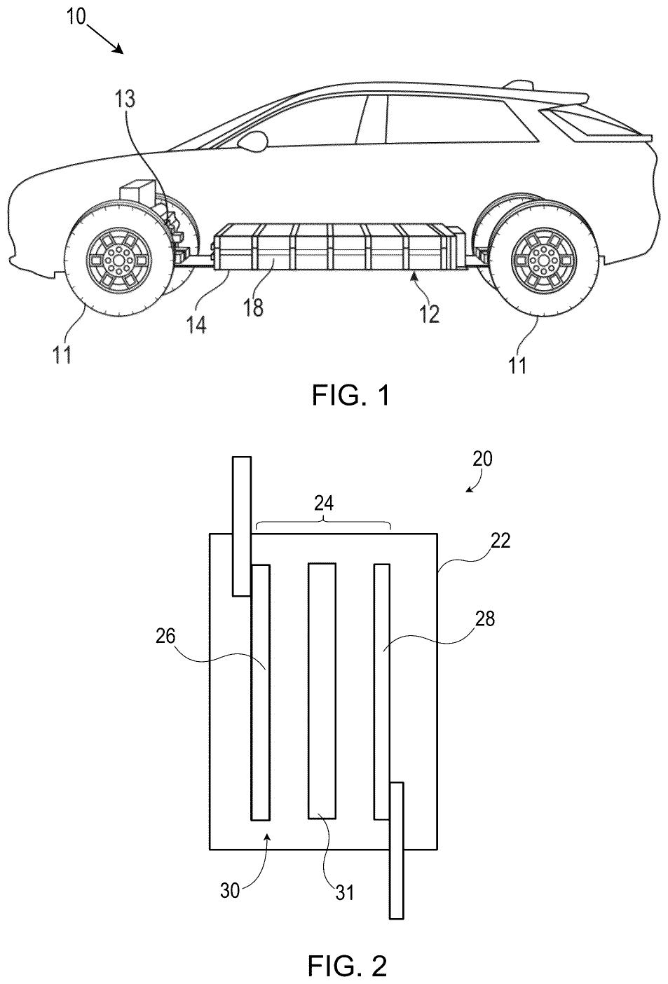

Referring to FIG. 1, a perspective view of a vehicle 10 having a battery pack 12 is illustrated, in accordance with the present disclosure. The battery pack 12 is illustrated with an exemplary vehicle 10. The vehicle 10 is an electric vehicle or hybrid vehicle having wheels 11 driven by electric motors/inverters 13. The electric motors/inverters 13 receive power from the battery pack 12. While the vehicle 10 is illustrated as a passenger road vehicle, it should be appreciated that the battery pack 12 may be used with various other types of vehicles. For example, the battery pack 12 may be used in nautical vehicles, such as boats, or aeronautical vehicles, such as drones or passenger airplanes. Moreover, the battery pack 12 may be used as a stationary power source separate and independent from a vehicle. Battery pack 12 includes a case 14 for supporting a plurality of battery cells 18. In an example, the battery pack 12 may have fifty or more battery cells 18.

Referring now to FIG. 2, a perspective view illustrates a battery 20 disposed within the battery pack 12 shown in FIG. 1, in accordance with an aspect of the present disclosure. Each battery 20 has a housing 22 or case, and at least one electrode stack 24, which includes a cathode 26, a lignin-derived hard carbon anode 28, an electrolyte 30, and a separator 31. Each battery 20 may have tens or hundreds of electrode stacks 24 with the hard carbon anodes 28. The electrode stacks 24 are placed in the housing 22 and the housing 22 is filled with a suitable electrolyte 30, and the electrode stacks 24 transmit electric current to an external circuit (not shown). The separator 31 is generally a thin porous membrane or layer of material that is positioned between the anode 28 and the cathode 26 and prevents the anode 28 and cathode 26 from touching and causing a short circuit. The separator 31 allows the ions (e.g., lithium ions) to pass through and complete the circuit.

Still referring to FIG. 2, the lignin-derived hard carbon anode 28 is formed of hard carbon, such as that discussed above. A positive charge/current flows into the battery 20 from an external circuit through the hard carbon anode 28. Hard carbon is a low-density material with extremely high microporosity and is often used as anode material in lithium-ion and sodium-ion batteries. A hard carbon anode 28 delivers a relatively higher reversible capacity and cycling stability than a graphite anode due to wider interlayer distance. Additionally, hard carbon has an enriched microcrystalline structure, which benefits the uptake of more Li⁺ ions and facilitates Lit ion intercalation and deintercalation.

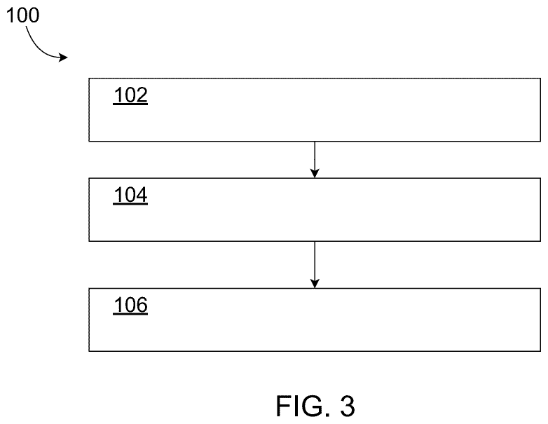

With reference to FIG. 3, a method 100 for forming hard carbon is presented, in accordance with the present disclosure. The method starts at block 102.

Block 102 depicts liquifying lignin in at least one of glycerol or glycerol/ethylene glycol with an acid catalyst to form a first monomer of liquified lignin. Lignin is a class of complex organic polymers that form key structures in support tissue of plants and is a by-product of the pulp and paper industry as well as biorefineries. Some types of lignin suitable for liquifying include kraft lignin, enzymatic lignin, sulfonated lignin, lignocellulose, and/or alkyl-lignin. Some types of suitable acid catalysts include sulfuric acid, phosphoric acid, nitric acid, and/or hydrochloric acid. Liquifying the lignin may include liquefaction of the lignin in a solvent, for example glycerol (e.g., purified, crude), glycerol/ethylene glycol, polyethylene glycol, and/or diethylene glycol. Crude glycerol is a low value byproduct produced in high volume by the biodiesel industry and is low cost and a potential renewable feedstock. In an example, the liquefaction of the lignin includes using between 10 wt. % and 90 wt. % lignin, between 10 wt. % and 90 wt. % crude glycerol, and between 0.1 wt. % and 50 wt. % acid catalyst. The method then moves to block 104.

Block 104 depicts providing a second monomer including a crosslinking reagent to the first monomer of liquified lignin. Adding the second monomer to the first monomer facilitates controlled polymerization of the liquified lignin and produces a thermoset or resin, which contributes to controlled size and morphology of the resulting resin or thermoset. The first monomer includes the liquified lignin including the lignin, the solvent (e.g., glycerol, glycerol/ethylene glycol), and/or the acid catalyst. The second monomer, or crosslinking agent, can include, for example, epoxy, isocyanate, formaldehyde, an acid, an acid chloride, and/or an ester. In an example, the first monomer and the second monomer are added and mixed in a ratio of 10 wt. %/90 wt. %. It will be appreciated that other first monomer and second monomer ratios may be implemented (e.g., 15 wt. %/85 wt. %, 20 wt. %/80 wt. %, and so forth).

As the first monomer and the second monomer are mixed, polymerization of the monomers may include a variety of methods. For example, polymerization can include bulk polymerization, spray polymerization, emulsion polymerization, and/or extrusion polymerization. A bulk polymerization reaction may be initiated by adding heat to or exposing the first monomer and the second monomer to radiation. As the polymerization reaction proceeds, the mixture becomes more viscous and ultimately forms the resin or thermoset. Spray polymerization includes forming the polymer with tiny droplets. Some examples of spray polymerization include thermal spray, electrospray, spray drying, ultrasonic spraying, and/or electricity-assisted subsonic and supersonic blowing. Emulsion polymerization occurs by mixing the monomers and colloidal particles containing the polymer form. Extrusion polymerization occurs when polymer material, including the first monomer and the second monomer, are fed into an extruder, which conveys the polymer material. As the polymer material moves through the extruder, heat softens and melts the polymer material, which is forced through a die, resulting in formation of the polymer and/or the resin. Method 100 then moves to block 106.

Block 106 depicts pyrolyzing the resin to form the hard carbon with a controlled morphology. Pyrolyzing the resin includes thermal decomposition of the resin in an inert or oxygen-free environment. Pyrolyzing the resin may include heating the resin to a temperature between 700° C. and 1600° C. in an inert and/or an oxygen-free environment to form hard carbon with a spherical morphology, which may be especially suited for use in a hard carbon anode 28. Method 100 then ends.

The hard carbon, method, and hard carbon anode of the present disclosure is advantageous and beneficial over the prior art. The hard carbon disclosed herein is derived from pyrolysis of the thermosetting material (resin) using feed stocks including lignin, glycerol, and/or ethylene glycol with an acid catalyst and crosslinking reagents. This hard carbon allows for lower cost hard carbon anode production because a majority of biomass used as the feed stock includes biowaste feeds including the lignin and crude glycerol, for example. Moreover, using biowaste as a feed stock to make thermosetting polymers allows for morphology control and tunability of polymers before pyrolysis, which in turn allows for control over characteristics of the hard carbon.

This description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims.

What is claimed is:

1. A method for forming hard carbon, comprising:
liquifying lignin in at least one of glycerol or glycerol/ethylene glycol with an acid catalyst to form a first monomer of liquified lignin;
providing a second monomer including a crosslinking reagent to the first monomer of liquified lignin to facilitate controlled polymerization resulting in a resin having controlled size and morphology; and
pyrolyzing the resin to form the hard carbon with a controlled morphology,
wherein the first monomer and the second monomer are provided in a ratio of 10 wt. % to 90 wt. %.

2. The method of claim 1, wherein the lignin includes at least one of kraft lignin, enzymatic lignin, sulfonated lignin, lignocellulose, or alkyl-lignin.

3. The method of claim 1, wherein the lignin is between 10 wt. % and 90 wt. % of the liquified lignin.

4. The method of claim 1, wherein liquifying the lignin includes using glycerol in an amount between 10 wt. % and 90 wt. % of the liquified lignin.

5. The method of claim 1, wherein liquifying the lignin includes using glycerol/ethylene glycol in an amount between 10 wt. % and 90 wt. % of the liquified lignin.

6. The method of claim 1, wherein the acid catalyst is between 0.1 wt. % and 50 wt. % of the liquified lignin.

7. The method of claim 1, wherein the acid catalyst includes at least one of phosphoric acid or hydrochloric acid.

8. The method of claim 1, wherein the acid catalyst includes at least one of nitric acid or sulfuric acid.

9. The method of claim 1, wherein the crosslinking reagent includes at least one of epoxy or isocyanate.

10. The method of claim 1, wherein the crosslinking reagent includes at least one of formaldehyde or an ester.

11. The method of claim 1, wherein the crosslinking reagent includes at least one of an acid or an acid chloride.

12. The method of claim 1, wherein providing a controlled polymerization includes using bulk polymerization.

13. The method of claim 1, wherein providing a controlled polymerization includes using spray polymerization.

14. The method of claim 1, wherein providing a controlled polymerization includes using emulsion polymerization.

15. The method of claim 1, wherein providing a controlled polymerization includes using extrusion polymerization.

16. The method of claim 1, wherein pyrolyzing the resin includes pyrolyzing the resin at a temperature between 700° C. and 1600° C.

17. The method of claim 1, wherein the hard carbon has a spherical morphology.

18. A hard carbon for forming a hard carbon anode, comprising:
a lignin-derived hard carbon having a spherical morphology, wherein the lignin-derived hard carbon is formed by:
liquifying lignin in at least one of glycerol or glycerol/ethylene glycol with an acid catalyst to form a liquified lignin;
providing controlled polymerization by adding a crosslinking reagent to the liquified lignin resulting in a resin having a controlled size and morphology; and
pyrolyzing the resin to form the hard carbon with a controlled morphology.

19. The hard carbon for forming a hard carbon anode of claim 18, wherein the lignin includes at least one of kraft lignin, enzymatic lignin, sulfonated lignin, lignocellulose, or alkyl-lignin.

20. A hard carbon anode, comprising:
an anode including lignin-derived hard carbon having a spherical morphology, wherein the lignin-derived hard carbon is formed by:
liquifying lignin in at least one of glycerol or glycerol/ethylene glycol with an acid catalyst to form a liquified lignin;
providing controlled polymerization by adding a monomer including a crosslinking reagent to a monomer including the liquified lignin resulting in a resin having a controlled size and morphology; and
pyrolyzing the resin to form the hard carbon with a controlled morphology.
